(19) United States
(12) Patent Application Publication
(10) Pub. No.: US 2006/0156884 A1
(43) Pub. Date: Jul. 20, 2006

(54) Device for separating profile pieces

(76) Inventors: Dietmar Gruber, Schlierbach (AT); Wolfgang Gasselseder, Oberneukirchen (AT); Erwin Krumbock, Ansfelden (AT)

Correspondence Address: WILLIAM COLLARD;COLLARD & ROE, P.C., 1077 NORTHERN BOULEVARD, ROSLYN, NY, 11576, US

(21) Appl. No.: 10/559,439

(22) PCT Filed: Mar. 15, 2005
(86) PCT No.: PCT/AT05/00092

§ 371 Date: Dec. 2, 2005

(30) Foreign Application Priority Data
Mar. 17, 2004 (AT) A 468/2004

(51) Int. Cl. B23D 19/00

(52) U.S. Cl. 83/469

(57) ABSTRACT

An apparatus is shown for severing profile pieces of an extruded profile strand (1) moved in its longitudinal extension, comprising a carriage (3) which is movable along the profile strand (1) and comprises a severing device with a saw blade (7) and at least two clamping jaws (5, 6) for holding in a non-displaceable manner the carriage (3) on the profile strand (1), and comprising a control device (13) connected with the clamping jaws (5, 6) and the severing device, which control device triggers the clamping jaws (5, 6) and the severing device depending on a predetermined length of the profile piece. In order to provide advantageous constructional conditions it is proposed that the severing device is associated with a knife (8) which can be moved transversally to the longitudinal extension of the profile strand (1), and that the control device (13) comprises a selector circuit (16) for optionally severing a profile piece with the saw blade (7) or the knife (8).

### FIELD OF THE INVENTION

The invention relates to an apparatus for severing profile pieces of an extruded profile strand moved in its longitudinal extension, comprising a carriage which is movable along the profile strand and comprises a severing device with a saw blade and at least two clamping jaws for holding in a non-displaceable manner the carriage on the profile strand, and comprising a control device connected with the clamping jaws and the severing device which triggers the clamping jaws and the severing device depending on a predetermined length of the profile piece.

### DESCRIPTION OF THE PRIOR ART

In order to enable severing a profile strand produced by an extrusion machine into profile pieces it is known to provide the extrusion machine downstream with an apparatus for severing profile pieces, which apparatus comprises a severing device with a rotating saw blade. To ensure that the longitudinal movement of the profile strand can be neglected during the sawing, such apparatuses comprise a carriage which is co-moved with the profile strand during the sawing. When a profile piece is to be severed, a control device triggers at least two clamping jaws on the carriage in order to thus connect the carriage in a non-displaceable way with the profile strand on the one hand and to hold down the severing region of the profile strand on the carriage during the sawing, whereupon the severing device is then triggered in the known manner for sawing through the profile strand. Although such apparatuses have proven their worth, chips are obtained during sawing. Such chips cause dust pollution and soiling of the apparatus, the ambient environment and the profile pieces per se in addition to higher material consumption. In addition to protective devices against ejection of the chips, these apparatuses also comprise devices for collecting the sawdust, leading to a considerably high constructional effort. Other chip-free severing devices have proven their worth only within limitations because it is demanded from such devices that they provide a comparatively high indifference to extrusion-induced changes in the quality of a profile strand. Such a high amount of indifference cannot be provided by the known use of a clamping jaws which are adjusted to the set profile for holding down a profile strand. Agglutinations or deviations of the profile strand from its required shape lead to the consequence that when a knife is used for cutting the profile strand the blade of the knife is overstressed and a fracture of the knife may occur.

### SUMMARY OF THE INVENTION

The invention is thus based on the object of providing an apparatus for severing profile pieces of the kind mentioned above with a comparatively low constructional effort in such a way that despite extrusion-induced changes in the dimensions of the profile strand the loss of material during the severing of the profile piece is kept as low as possible. Moreover, this apparatus shall be characterized by its reliability and long service life.

This object is achieved in such a way that the severing device is associated with a knife which can be moved transversally to the longitudinal extension of the profile strand and that the control device comprises a selector circuit for optionally severing the profile piece with the saw blade or the knife.

When the severing device with the saw blade is also associated with a knife which can be moved transversally to the longitudinal extension of the profile strand, then this provides not only simple constructional conditions since the carriage already present can also be used for carrying the knife, but it is also possible that the clamping jaws provided for the saw blade can be used for the knife. When these clamping jaws do not hold down the profile strand precisely, this does not pose any problem to the rotating saw blade. The knife will only be used in accordance with the invention when the profile strand has a high precision in its shaping and the clamping jaws ensure a precise holding down of the profile strand. For this purpose the control device comprises a selector circuit with which it is possible to choose between a severing of the profile piece with a saw blade or the knife. A comparatively simple apparatus is thus created as compared with known apparatuses, which is not only indifferent to the extrusion conditions and can thus exclude a breakage of the knife, but also keeps the loss of material during the severing of a profile piece as low as possible. Moreover, the apparatus in accordance with the invention can be produced in a comparatively cost-effective way because carriage, control device and clamping jaws can be used jointly by the saw blade and the knife.

Especially advantageous constructional conditions are obtained when the knife is laterally offset relative to the sawing plane of the saw blade and at least the saw blade and the knife are encompassed by a common housing on the carriage.

When the control device considers a corrective value depending on the evaluation circuit when activating the clamping jaws and the severing device, the constructional lateral distance between knife and saw blade can be included during the severing of a profile piece. The control device can thus correct the position of the carriage relative to the profile piece with the knowledge of the lateral distance. Simple constructional conditions are obtained when the control device reads out the corrective value from a memory depending on the evaluation circuit, which corrective value can be read into the memory of the apparatus through an input device and can thus be changed.

When the knife consists of a knife disk which is rotatably held about an axis parallel to the longitudinal extension of the profile strand, the indifference of the knife against extrusion-induced deviations of the profile strand from its required shape can be increased during the cutting of the profile strand by allowing the knife to roll off on the carriage.

### BRIEF DESCRIPTION OF THE DRAWINGS

The subject matter of the invention is shown by way of example in the drawings, wherein:

FIG. 1 shows a side view of the apparatus for severing profile pieces with a knife guided vertically to the carriage, and

FIG. 2 shows a sectional view of a severing device of FIG. 1 where a horizontally guided knife is used instead of the knife guided vertically relative to the carriage.

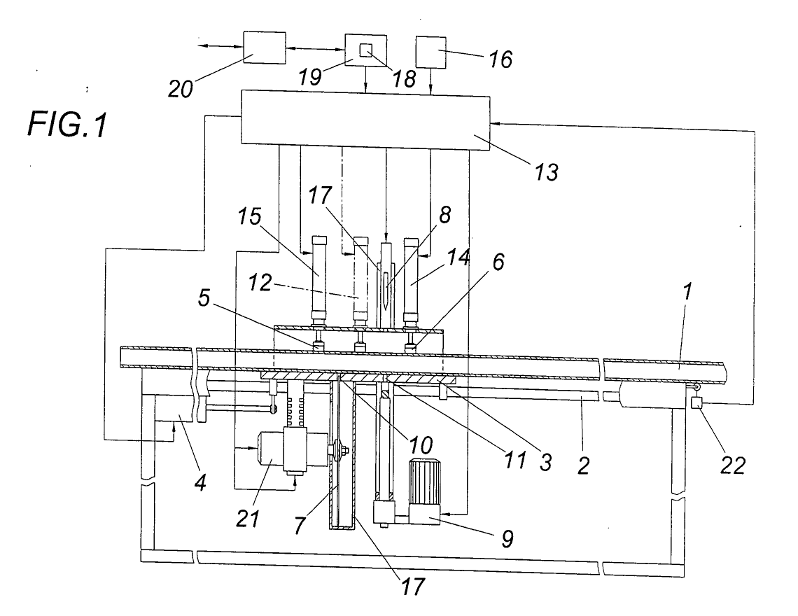

According to the illustrated embodiment (FIG. 1), the apparatus comprises a carriage 3 which is held in a displaceable fashion along an extruded profile strand 1 on guide rods 2 and which is moved by means of a displacing drive 4. The displacing drive 4 can merely be used for returning the carriage 3 to its initial position because a co-movement of the carriage 3 with the moved profile strand 1 can be performed through a holding of the clamping jaws 5 and 6 on the profile strand 1, which cylinder-pressurized clamping jaws 5 and 6 are provided on the carriage 3. Moreover, a severing device with a saw blade 7 and a knife 8 is provided on carriage 3, with the saw blade 7, which is driven by a motor 21, and the knife 8 can each be moved in the known manner transversally relative to the longitudinal extension of the profile strand 1. The knife 8 is clamped on either side in guide means extending perpendicularly to the longitudinal direction of the profile strand at a distance to the profile strand, allowing a displacement of the knife in the direction of profile strand 1 in the manner of a guillotine. A drive 9 is provided for the height adjustment of the knife. Saw blade 7 and knife 8 are arranged in a mutually offset manner on the carriage 3 for sake of simplicity. It is also possible to arrange the knife 8 and the saw blade 7 without any lateral distance in order to thus keep the carriage length at a low level. The carriage 8 further comprises recesses 10 and 11 for the saw blade 7 and the knife 8. The guide means of the knife 8 are provided on both sides of the carriage. When a profile piece of predetermined length is to be severed from the profile strand 1, a control device 13 activates the displacing drive 4, so that the carriage 3, starting from its idle position (not shown in closer detail), is entrained in the region of the entrance of the profile strand 1 with the moved profile strand 1. The cylinders 14 and 15 are then triggered by the control device 13 in order to thus join the carriage 3 with the profile strand 1 in a non-displaceable manner and to also hold down the profile strand 1 in the severing region on the carriage. In order to support the holding down of the profile strand 1 in the severing region, a further cylinder 12 with a clamping jaw can be provided, which is shown in the drawing with the dot-dash line.

To ensure that the control device 13 can calculate the profile strand length moved past the carriage 3, a roller sensor 22 is provided which rests on the profile strand 1 and which is connected with the control device 13. The position of the carriage 3 is known to the control device 13 by way of the displacing drive 4. The control device 13 can trigger the severing device depending on a selector circuit 16, such that either the severing shall occur by the saw blade 7 or by the knife 8. The selector circuit 16 can record the precision of the profile strand 1 by way of sensors for example, so that a decision on the respective severing with the saw blade 7 or the knife 8 can be performed by the apparatus, which is not shown in closer detail. It is also possible that this decision is made by the operators or is entered via a pushbutton into the selector circuit 16.

A joint housing 17 for the saw blade 7 and the knife 8 is provided on the carriage 3.

Depending on the selector circuit 16, the control device 13 includes a corrective value 18 in triggering the displacing drive 4 or the clamping jaws 14 and 15 in order to thus take into account the lateral distance between the saw blade 7 and the knife 8. This corrective value 18 is stored in a memory 19 which can be changed via an input device 20.

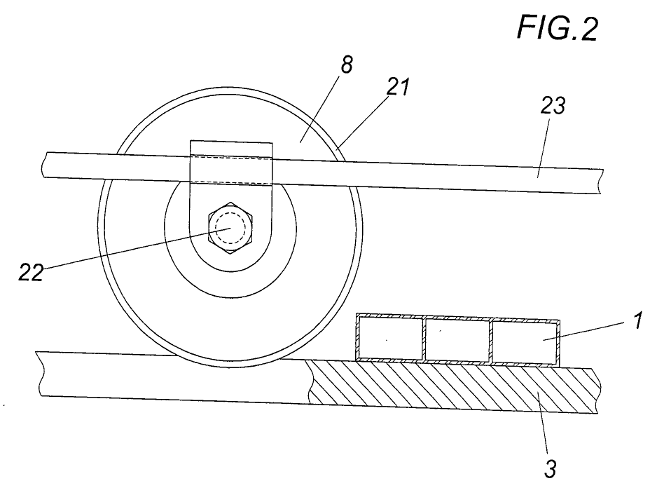

Instead of the knife configuration in the manner of a guillotine, the knife 8 can consist of a knife disk 21 which is rotatably held about an axis 22 parallel to the longitudinal extension of the profile strand 1 (FIG. 2). The knife disk 21 is rolled off in a groove on carriage 3 transversally to the profile strand 1, for which purpose a guide rod 23 is provided which is attached to carriage 3 (not shown in closer detail).

1. An apparatus for severing profile pieces of an extruded profile strand (1) moved in its longitudinal extension, comprising a carriage (3) which is movable along the profile strand (1) and comprises a severing device with a saw blade (7) and at least two clamping jaws (5, 6) for holding in a non-displaceable manner the carriage (3) on the profile strand (1), and comprising a control device (13) connected with the clamping jaws (5, 6) and the severing device, which control device triggers the clamping jaws (5, 6) and the severing device depending on a predetermined length of the profile piece, wherein the severing device is associated with a knife (8) which can be moved transversally to the longitudinal extension of the profile strand (1), and that the control device (13) comprises a selector circuit (16) for optionally severing the profile piece with the saw blade (7) or the knife (8).

2. An apparatus according to claim 1, wherein the knife is laterally offset relative to the sawing plane of the saw blade (7) and at least the saw blade (7) and the knife (8) are encompassed by a common housing (17) fastened to the carriage (3).

3. An apparatus according to claim 1, wherein the control device (13) considers a corrective value (18) based on the distance between the saw blade (7) and the knife (8) depending on the selector circuit when triggering the clamping jaws (5, 6) and the severing device.

4. An apparatus according to claim 3, wherein an input device (20) for reading in the corrective value (18) is connected with a memory (19) of the apparatus, and that the control device (13) reads out the corrective value (18) from the memory (19) depending on the selector circuit (16).

5. An apparatus according to one of the claims 1 to 4 claim 1, wherein the knife (8) consists of a knife disk (21) which is rotatably held about an axis (22) parallel to the longitudinal extension of the profile strand (1).
